(19) United States
(12) Patent Application Publication
(10) Pub. No.: US 2005/0053711 A1
(43) Pub. Date: Mar. 10, 2005

(54) Mixture for preparing a slimming coffee drink

(76) Inventor: Ilya Gerchikov, Riga (LV)

Correspondence Address: Valentina Sergeyeva, 8, Zardu Street, Riga, LV-1083, LV

(21) Appl. No.: 10/921,123

(22) Filed: Aug. 19, 2004

(30) Foreign Application Priority Data
Aug. 19, 2003 (LV) P-03-94

(51) Int. Cl. A23F 5/00

(52) U.S. Cl. 426/594

(57) ABSTRACT

The invention pertains to the field of food industry, in particular, to food supplements in the form of nonalcoholic drinks. The proposed coffee drink mixture assists slimming while retaining habitual nutrition regimen, and providing high capacity for work and vivacity. Appetite inhibition is achieved naturally by inhibiting craving for sweet stuffs. The mixture contains coffee, cacao, alimentary kelp, caramelized barley malt and guarana seeds extract. The components are mixed with a certain quantitative ratio.

The invention relates to the field of food industry, in particular, to food supplements in the form of nonalcoholic beverages.

### CROSS REFERENCE TO RELATED APPLICATIONS:

1. Dr. GREEN Natural Products—Ein Yahav D. N. Arava, Israel 86820

2. A slimming coffee mixture Delice & Minceur (www.cofe-m.ru, Arlor, FR)

### BACKGROUND OF THE INVENTION

In “Dr. Green's Slimming Coffee”, a weight reduction coffee based mixture has been disclosed, containing natural coffee, I-carnitine, guar gum, chromium nicotinate and hydro citric acid (HCA), (see “Dr. GREEN Natural Products”, Ein Yahav D. N. Arava, Israel 86820).

Another prior art mixture is a slimming coffee mixture Delice & Minceur (www.cofe-m.ru, Arlor, FR), which has the closest technical substance to the claimed one and contains as ingredients coffee (roasted “Arabica” coffee and raw “Arabica” coffee extract), vegetable extracts (wheat extract, lupine extract), and fruit-oligosaccharides, vitamin PP and amino acid chromium complexes.

The above mentioned mixture when consumed as a drink with addition of non-fat milk, artificial sweetener, lemon juice and vitamin C, contributes to body weight reduction providing for lipolysis and eduction of lipolysis products from adipose-cellular tissue. Appetite inhibition is achieved artificially by introducing the chromium preparation.

### BRIEF SUMMARY OF THE INVENTION

The purpose of the present invention is a coffee-based drink that simultaneously solves the 3 most vital problems for people with excess weight who wish to become slimmer:

improves body metabolism and contributes to lipolysis;

creates a feeling of satiety, inhibits appetite and craving for sweet stuffs;

energizes and increases capacity for work.

The proposed coffee drink mixture contributes to slimming while retaining habitual nutrition regimen, high capacity for work and vivacity. With this, appetite inhibition is achieved naturally by inhibiting craving for sweet stuffs.

The proposed mixture effectively contributes to slimming by stimulating and improving metabolism and active lipolysis due to introduction of coffee powder, guarana extract and cacao powder into the recipe. The above mentioned components having high caffeine contents, they provide for rapid lipolysis.

Lipolysis by-products are then duly removed from the body with the help of seaweed (kelp) powder; therefore there is neither intoxication nor accumulation of by-products in the body. Guarana stimulating potential is 2-5 times higher than that of coffee, therefore its impact on body metabolism is higher; and combined application of coffee powder and guarana extract provides for even higher impact than each of the two products separately.

Satiety and appetite inhibition are achieved naturally by complex application of such natural components as cacao, kelp and barley. Moreover, craving for sweet stuffs is also reduced, which is desirable for people with excess body weight. The secret of cacao is contained in its composition. Cacao beans contain theobrome, a natural cardio and nervous system stimulator; caffeine, and also phenylaphylamine, an energizer, and other wholesome ingredients. Cacao is a low-cal, but high energy product, which is especially of importance for people with excess weight. Research proves that cacao, although being higher in calories than tea or coffee, does not lead to body weight gain. The reason for this is that even a small portion of cacao evokes satiety; consequently a person does not overeat.

Kelp consumption inhibits appetite due to evoking satiety. Kelp thalluses absorb water and inflate, significantly growing in volume. With this, stomach receptors, which respond to mechanical effect, are irritated and satiety arises, serving as a signal to stop food consumption.

Barley products are recommended to people with excess body weight due to high fiber contents, which is practically not assimilated and fills the stomach evoking satiety.

Fiber also acts as a physical irritant of intestines walls, increasing their peristalsis thus leading to duly eduction of by-products.

Introducing cacao, kelp and barley into the mixture contents provides body with an additional energy supply and rapidly evokes satiety, thus inhibiting appetite.

High caffeine contents in coffee beans, guarana extract; as well as high chlorogenine acid contents of coffee powder have a strong restorative effect on body, energize and increase capacity for work.

### DETAILED DESCRIPTION OF THE INVENTION

According to the invention, the objective put forth is achieved by introducing into the slimming drink preparation mixture containing coffee, vegetable extracts and components, further additives including cacao, caramelized barley malt, alimentary kelp and guarana seeds extract as vegetable components, at the following ratio, mass %,:

| | |
|---|---|
| Cacao | 15.00-35.00 |
| Alimentary kelp | 4.00-10.00 |
| Caramelized barley malt | 4.00-10.00 |
| Guarana seeds extract | 1.00-8.00 |
| Coffee | Balance |

An aromatizing agent (1.0-6.0%) and a flavor additive are introduced into the contents to improve aroma and taste accordingly.

Ingredients characteristics:

Cacao (Theobroma Cacao L.) Introduced into the contents as powder. Cacao beans contain theobrome, a natural cardio and nervous system stimulator, caffeine, and also phenylaphylamine, an energizer, and other wholesome ingredients. Introduction into the contents at the ratio of 15-35% provides an additional source of energy for the body, inhibits appetite and tones up very well.

Alimentary kelp (Laminaria japonica), beige to light greenish-brown powder, is grated seaweed with high iodine content, high-molecular polysaccharides, mostly alginic acid salts, alaminarine (up to 21%), alginic acid (up to 25%), mannitol (up to 21%), fructose (up to 4%), vitamins B1, B2, A, C, D, E. Regular kelp consumption makes up for vitamin and mineral deficiency, iodine deficiency, normalizes metabolism and thyroid gland functioning, improves immune system. It also positively influences cardiovascular, haematogenic and nervous systems; facilitates decay products, toxins etc. eduction, regulates gastrointestinal tract functioning and promotes body weight reduction. Introduction of 4-10% of alimentary kelp into the mixture inhibits appetite due to evoking of satiety.

Caramelized barley malt (Hordeum Vulgare L.) is germinated and specifically processed barley grains, which contain up to 40% of starch, 10% of proteins, 10% of dextrine, 30% of fiber, enzyme-peptide, minerals and salts. Barley malt is recommended to people with excess body weight due to high fiber contents, which is practically not assimilated and fills the stomach evoking satiety.

Coffee is introduced into the mixture in the form of grated coffee beans, for example, “Arabica” sort (Coffea arabica). Coffee beans contain chlorogenine acid (see comments) (up to 7%) as well as proteins, fats, carbohydrates, vitamins and minerals, which stimulate cardiac activity and energize. Chlorogenine acid is a powerful antioxidant, neutralizing free radicals, preventing cell and fiber destruction; it also renders restorative effect. Caffeine assists rapid lipolysis in the body, stimulates nervous system activity, improves brain activity, increases overall capacity for work and stamina; it also normalizes energy circulation, provides for gall-bladder cleansing. When prepared correctly, caffeine also impedes forming of cholesteric clogging.

Guarana seeds extract (Paullinia Cupana) is grated to powder light-grey dry seed bitter extract. It contains such active components as caffeine (up to 16%), theobromine, theophylline, tannin and others. Guarana improves metabolism, accelerates lipolysis and adrenaline discharge. It also renders restorative effect on the body and stimulates mental activity. Guarana also increases stamina, vitality and capacity for work.

Comparative analysis shows that the proposed coffee based mixture differs from the known mixture in novel components and new quantitative ratio of the components. All components in the mixture contents are known; however, when combined with other components in claimed qualitative ratios, a new positive effect is achieved.

Instruction for Preparation:

Components are grated to particle size 0.1-0.3 microns, uniformly mixed and packaged. To prepare the drink add 2 teaspoons of mixture to a 140 ml cup, pour boiling water, stir and let it brew in the course of 20 minutes. Take 3 times per day before meals daily in the course of 1 month.

The proposed mixture variants having the claimed quantitative ratios are presented in Tables 1, 2, 3 below.

TABLE 1

| | |
|---|---|
| Cacao powder | 15.00 |
| Grated alimentary kelp | 4.00 |
| Caramelized barley malt | 4.00 |
| Grated guarana extract | 1.00 |
| Flavor additive | 0.10 |
| Flavoring | 1.00 |
| Grated coffee beans | 74.90 |

The drink prepared from the above mixture has a good restorative effect, gives a feeling of vivacity, high capacity for work, and inhibits appetite.

TABLE 2

| | |
|---|---|
| Cacao powder | 20.00 |
| Grated alimentary kelp | 7.50 |
| Caramelized barley malt | 7.50 |
| Grated guarana extract | 5.00 |
| Flavor additive | 1.00 |
| Flavoring | 4.00 |
| Grated coffee beans | 55.00 |

The drink prepared from the above stated mixture has a good restorative effect, gives a feeling of vivacity and high capacity for work, and noticeably inhibits appetite and craving for sweet stuffs.

TABLE 3

| | |
|---|---|
| Cacao powder | 35.00 |
| Grated alimentary kelp | 10.00 |
| Caramelized barley malt | 10.0 |
| Grated guarana extract | 8.00 |
| Flavor additive | 2.50 |
| Flavoring | 6.00 |
| Grated coffee beans | 28.50 |

The drink prepared from the above stated mixture evokes satiety, noticeably inhibits craving for sweet stuffs and provides for a substantial restorative effect.

People with a critical perception of their figure and body weight are to take the proposed coffee drink 3 times per day approximately 20 min before meals daily without adding sugar in the course of minimum 1 month. With this, when keeping to a diet, there is neither tiredness nor hunger experienced. The drink inhibits appetite and is a perfect supplement to figure correction programs (anti-cellulite etc.). It allows maintaining stable body weight, improves state of health and charges you with vivacity for the whole day.

1. A mixture for preparing a slimming coffee-based drink, comprising coffee, vegetable components and vegetable extracts, characterized in that the mixture contains alimentary kelp as vegetable component and guarana seeds extract as vegetable extract and further cacao and caramelized barley malt, at the following component ratio, mass %,:

| | |
|---|---|
| Cacao | 15.00-35.00 |
| Alimentary kelp | 4.00-10.00 |
| Caramelized barley malt | 4.00-10.00 |
| Guarana extract | 1.00-8.00 |
| Coffee | Balance |

2. A mixture for preparing a slimming coffee drink as claimed in claim 1, characterized in that the mixture further comprises aromatizing agent in amount of 1.00 to 6.00% by mass and flavor additive in amount of 0.10 to 2.50% by mass.
